(19) United States
(12) Patent Application Publication
(10) Pub. No.: US 2025/0295064 A1
(43) Pub. Date: Sep. 25, 2025

(54) REMOTE HARVESTER PROPULSION CONTROL

(71) Applicant: Deere & Company, Moline, IL (US)

(72) Inventor: Scott N. Clark, Bettendorf, IA (US)

(21) Appl. No.: 18/609,280

(22) Filed: Mar. 19, 2024

(51) Int. Cl. A01D 41/127; A01D 57/00

(52) U.S. Cl. CPC A01D 41/1274; A01D 57/00

(57) ABSTRACT

An agricultural vehicle may include, among other features, an electronic controller including one or more processors and a non-transitory computer-readable storage medium coupled to the one or more processors and storing programming instructions for execution by the one or more processors. The programming instructions instruct the one or more processors to operate one of a propulsion system and a feederhouse position system in response to one or more inputs applied to a propulsion input device on or coupled to the agricultural vehicle. The propulsion system of the agricultural vehicle may be operable to drive a ground engaging component of the agricultural vehicle in a first direction or a second configuration in response to an input received from an input device. The feederhouse position system may be operable to alter a position of the feederhouse, such as rotation about a lateral axis, rotation about a longitudinal axis, or both.

### FIELD OF THE DISCLOSURE

The present disclosure relates generally to propulsion control and, particularly, propulsion control of an agricultural harvester from a location remote from a control station of the agricultural harvester.

### BACKGROUND OF THE DISCLOSURE

In some cases, agricultural machines, such as combine harvesters, include a hitch at an aft end thereof. The hitch is used to connect to another component that can then be towed by the agricultural vehicle. Generally, an operator located in a cab of the agricultural machine controls movement, both speed and direction, in order to align the agricultural machine with the component to be towed.

### SUMMARY OF THE DISCLOSURE

A first aspect of the present disclosure is directed to an agricultural harvester. The agricultural harvester may include a frame; a body coupled to the frame; a feederhouse movable relative to the body; a feederhouse position system configured to move the feederhouse; and a ground engaging component coupled to the frame. The ground engaging component may be configured to move the agricultural harvester over a surface. The agricultural harvester may also include a propulsion system configured to drive the ground engaging component and a propulsion input device in communication with the propulsion system and the feederhouse position system. The propulsion input device may be configured to receive input to control operation of the propulsion system and the feederhouse position system. The agricultural harvester may also include an electronic controller communicably coupled to the propulsion input device. The electronic controller may include one or more processors and a non-transitory computer-readable storage medium coupled to the one or more processors and storing programming instructions for execution by the one or more processors. The programming instructions may instruct the one or more processors to: operate the propulsion system in one of a first configuration to drive the ground engaging component in a first direction or a second configuration to drive the ground engaging component in a second direction, opposite the first direction, in response to a first input received by the propulsion input device; cease operation of the propulsion system in response to cessation of the first input being applied to the propulsion input device; and move the feederhouse relative to the body in response to a second input received by the propulsion input device. The propulsion system may be operated for a duration of time that the propulsion input device receives a first input.

Another aspect of the present disclosure is directed to a computer-implemented method for controlling movement of an agricultural harvester. The computer-implemented method may include operating a propulsion system of the agricultural harvester in one of a first configuration to drive a ground engaging component of the agricultural harvester in a first direction or a second configuration to drive the ground engaging component in a second direction, opposite the first direction, in response to a first input received by a propulsion input device of the agricultural harvester and operating a steering system to pivot the ground engaging component relative to at least a portion of a frame of the agricultural harvester in response to a second input received by the propulsion input device, operation of the steering system continuing for so long as the second input is received by the propulsion engaging device. The propulsion system may be operated for a duration of time that the propulsion input device receives a first input.

The various aspects of the present disclosure may include one or more of the following features. The programming instructions may include programming instructions to instruct the one or more processors to maintain movement of the feederhouse relative to the body for so long as the second input is received by the propulsion input device and cease movement of the feederhouse in response to cessation of the second input being applied to the propulsion input device. The programming instructions that include programming instructions to instruct the one or more processors to move the feederhouse relative to the body in response to a second input received by the propulsion input device may include programming instructions to instruct the one or more processors to at least one of pivot the feederhouse about a lateral horizontal axis and pivot the feederhouse about a longitudinal horizontal axis. A steering system may be included, and the steering system may be configured to alter a configuration of at least one of the ground engaging components. The programming instructions may include program instructions to instruct the one or more processors to cause the steering system to pivot the ground engaging component relative to at least a portion of the frame in response to a third input received by the propulsion input device and maintain pivoting of the ground engaging component for so long as the third input is received by the propulsion engaging device. The propulsion input device may be physically attached at a location of the agricultural harvester. The propulsion input device may be physically attached to the location via an electrical tether that provides communication with the electronic controller. The prolusion input device may be wirelessly communicably coupled to the electronic controller. The programming instructions may include programming instructions to instruct the one or more processors to enable operation of the propulsion input device in response to receipt of a third input. The body may include an operator station, and the third input may be received from the operator station. The operator station may be a cab of the body. A brake system may be included, and the propulsion system may include a transmission. The programming instructions that instruct the one or more processors to operate the propulsion system in one of a first configuration to drive the ground engaging component in a first direction or a second configuration to drive the ground engaging component in a second direction, opposite the first direction, in response to an input received from the input device, for a duration of time that the propulsion input device receives a first input may include programming instructions that instruct the one or more processors to: place the brake system in a release condition in which a braking force is not applied and operate the transmission to cause the propulsion system to operate in the one of the first configuration and the second configuration for as long as the first input is received from the propulsion system input. The programming instructions that instruct the one or more processors to cease operation of the propulsion system in response to cessation of the first input being applied to the input device may include programming instructions that instruct the one or more processors to place the brake system in an engaged condition in which the braking force is applied.

The various aspects of the present disclosure may also include one or more of the following features. Operation of the propulsion system may be ceased in response to cessation of the first input being applied to the propulsion input device. Operation of the steering system may be ceased in response to cessation of the second input being applied to the propulsion input device. Operation of the propulsion input device may be enabled in response to a third input. Enabling operation of the propulsion input device in response to the second input may include receiving the third input via an operator station of the agricultural harvester. Operating the propulsion system of the agricultural harvester in one of the first configuration to drive the ground engaging component of the agricultural harvester in the first direction or the second configuration to drive the ground engaging component in the second direction, opposite the first direction, in response to the first input received from the propulsion input device provided on the exterior surface of the agricultural harvester may include receiving the first input from the propulsion input device disposed at an aft portion of the agricultural harvester. Operating the propulsion system of the agricultural harvester in one of the first configuration to drive the ground engaging component of the agricultural harvester in the first direction or the second configuration to drive the ground engaging component in the second direction, opposite the first direction, in response to the first input received from the input device may include: disengaging a brake system of the agricultural harvester to release a brake force; and operating a transmission of the propulsion system to cause the propulsion system to operate in the one of the first configuration and the second configuration for as long as the first input is received from the propulsion system input device. Ceasing operation of the propulsion system in response to cessation of the first input being applied to the propulsion input device may include engaging the brake system to apply a brake force to the ground engaging component.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a side view with some schematic details of an example combine harvester connected with a header, according to some implementations of the present disclosure.

FIG. 2 is a side view of the combine harvester of FIG. 1 with the header positioned on a trailer located behind the combine harvester.

FIG. 3 is a front view of an example propulsion input device that includes a first button to cause movement in a first direction and a second button to cause movement in a second direction, according to some implementations of the present disclosure.

FIG. 4 is a schematic view of an example controller system for controlling movement of a combine harvester in response to operation of a propulsion input device, according to some implementations of the present disclosure.

FIG. 5 is a flowchart of an example method for moving a vehicle using an input device that is located remote from an operator station of the vehicle, according to some implementations of the present disclosure.

FIG. 6 is a block diagram illustrating an example computer system used to provide computational functionalities associated with described algorithms, methods, functions, processes, flows, and procedures as described in the present disclosure, according to some implementations of the present disclosure.

FIG. 7 are views of various example propulsion input devices, according to some implementations of the present disclosure.

FIG. 8 is a side view with some schematic details of an example combine harvester disconnected from a header, according to some implementations of the present disclosure.

FIG. 9 is a front view of an example propulsion input device that includes a plurality of input devices for controlling various aspects of a combine harvester, according to some implementations of the present disclosure.

FIG. 10 is a flowchart of an example method to manipulate a position of an agricultural vehicle, such as a combine harvester, for the purpose of coupling an implement, such as a header, to the agricultural vehicle, according to some implementations of the present disclosure.

FIG. 11 is a schematic view of an example controller system for controlling various systems of a combine harvester in response to operation of a propulsion input device, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Words of orientation, such as “up,” “down,” “top,” “bottom,” “above,” “below,” “leading,” “trailing,” “front,” “back,” “forward,” and “rearward,” used in the context of the provided examples would be understood by one skilled in the art and are not intended to be limiting to the disclosure. For example, for a particular type of vehicle in a conventional configuration and orientation and being operated in a conventional manner, one skilled in the art would understand these terms in the context in which they are used and as those terms apply to a particular vehicle. For example, one skilled in the art would appreciate what the forward direction is in the context of a direction that a combine harvester normally moves when actively harvesting crop during a crop harvesting operation. Further, one skilled in the art would appreciate what the reverse direction would be for the agricultural harvester during normal operation of the agricultural harvester.

Additionally, the term “forward” (and the like) corresponds to a forward direction of travel of a work machine (e.g., header or combine harvester), such as during a harvesting operation. Likewise, the term “rearward” or “reverse” (and the like) corresponds to a direction opposite the forward direction of travel. In this regard, for example, a “forward facing” feature on a header may generally face in the direction that the head travels during normal operation, while a “rearward facing” feature may generally face opposite that direction.

Also as used herein, with respect to a work machine, unless otherwise defined or limited, the term “leading” (and the like) indicates a direction of travel of the work machine during normal operation (e.g., the forward direction of travel of a harvester vehicle carrying a header). Similarly, the term “trailing” (and the like) indicates a direction that is opposite the leading direction. In this regard, for example, a “leading” edge of a header may be generally disposed at the front of the header, with respect to the direction travel of the header during normal operation (e.g., as carried by a combine harvester). Likewise, a “trailing” edge of a header may be generally disposed at the back of the header opposite the leading edge, with respect to the direction of travel of the header during normal operation.

Although the present disclosure is made in the context of agricultural harvesters (e.g., combine harvesters), the scope of the present disclosure is not so limited. Rather, the scope of the disclosure encompasses work machines in numerous other industries in which rearward visibility from an operator's station of the vehicle is obstructed or otherwise unavailable.

Agricultural harvesters, such as combine harvesters, are used to harvest crop. During a harvest operation, an agricultural harvester may harvester crop in different fields. In some instances, those fields are not adjacent or otherwise connected. Relocation of the agricultural harvester from one field to another may involve relocation of other items as well. For example, to move the agricultural harvester from one field to another may require that a header be removed from the agricultural harvester. For example, a width of the header may exceed a width of a roadway over which the agricultural harvester must travel in order to travel to a new location. As such, the agricultural harvester is moved from one field to the next to continue harvesting in a new field.

Transport of the removed header may involve towing the header to the new location. In some instances, the agricultural harvester may include a hitch or other device to couple to the header so that the agricultural harvester can tow the header to the new location. In some implementations, the header is aligned longitudinally when towed and may be coupled directly to the agricultural harvester or may be provided on a trailer that is coupled to the agricultural harvester. For the purpose of clarity, the disclosure describes the header as being connected or otherwise coupled to the agricultural harvester for transport of the header with the agricultural harvester. However, this description is intended to encompass coupling of the header directly and indirectly coupling the header to the harvester, such as with the use of a trailer.

Connecting the header to the agricultural harvester, whether directly or indirectly (e.g., via a trailer), poses challenges due to a lack of visibility of the operator. Generally, the hitch of a harvester is located on an aft portion of the agricultural harvester, and an operator within a cab, generally located at a forward portion of the harvester, is unable to directly view the hitch, all or a portion of the header, or both. Consequently, connecting the agricultural harvester to the header poses difficulty and increases time required to connect the header to the harvester.

The present disclosure is directed to systems, apparatuses, and methods for controlling movement of an agricultural vehicle, such as a combine harvester, from a location outside of an operator's station of the agricultural vehicle. In some instances, control of this operation is performed at a position on an aft portion of the agricultural vehicle. For example, movement of the agricultural vehicle is performed in response to manipulation of one or more controls provided at a location on or near an aft portion of the agricultural machine. More generally, the one or more controls may be located on the agricultural vehicle at a position such that, if an operator were positioned adjacent to the one or more controls, the operator would have rearward visibility and the ability to see the hitch and the header. In such a position, the operator is able to manipulate the controls to position the agricultural vehicle relative to the header to successfully connect one to the other.

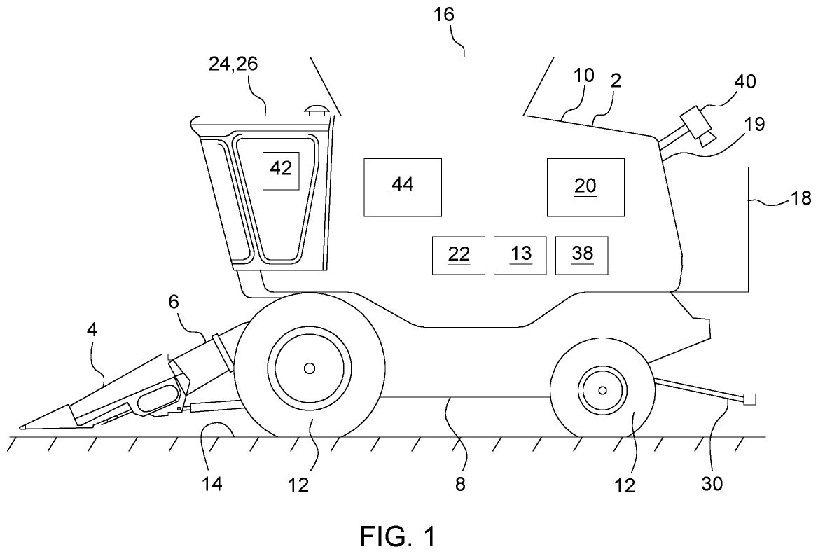

FIG. 1 is a side view of a combine harvester 2 with a header 4 connected to a feederhouse 6 of the combine harvester 2. The combine harvester 2 includes a frame 8, a body 10 mounted to the frame 8, and ground engaging components 12 coupled to the frame 8. The ground engaging components 12 operate to move the combine harvester 2 over a surface, such as the ground 14. Example ground engaging components 12 include wheels (e.g., a combination of wheels and tires), tracks, or other components or assemblies that function to move the agricultural harvester 2 over a surface. The combine harvester 2 also includes a steering system 13 that operates to move (e.g., pivot) one or more of the ground engaging components 12 (e.g., the two rear ground engaging components 12) to steer the combine harvester 2. In some instances, the forward ground engaging components 12 are steered. In still other implementations, all ground engaging components 12 are movable to effectuate steering of the combine harvester 2. In some implementations, the steering system causes one portion of a vehicle to move relative to another portion of the vehicle to effectuate steering, such as in the context of an articulated machine. The combine harvester 2 includes processing components within the body 10 that process the harvested crop. Clean grain extracted from the harvested crop is stored within a grain tank 16, and residue from the harvested crop is handled by a residue system 18. The residue system 18 expels the residue from the combine harvester 2, such as in a windrow or a distribution spread behind the combine harvester 2. The residue system 18 may include a chopper that chops residue, e.g., straw and other non-grain components of the harvested crop, prior to expulsion of the residue from the combine harvester 2. The residue system 18 is movable between a raised position and a lowered position. When the residue system 18 is raised, a vertical distance between at least a portion of the residue system 18 and the ground 14 is increased. When the residue system 18 is lowered, a vertical distance between at least a portion of the residue system 18 and the ground 14 is decreased. All or part of the residue system 18 is provided at an aft end 19 of the combine harvester 2.

During a harvesting operation, the header 4 operates to harvest crop and transport the harvested crop to the feederhouse 6. The feederhouse 6 conducts the crop into the body 10 for processing by the processing components. The resulting clean grain is transported to the grain tank 16, and the resulting crop residue is conveyed to the residue system 18, from which the residue is expelled from the combine harvester 2.

The combine harvester 2 also includes a propulsion system 20 and a brake system 22. The propulsion system 20 operates to propel the combine harvester 2, such as by driving one or more of the ground engaging components 12 to move the combine harvester 2 over the ground 14. In some instances, the propulsion system 20 includes one or more of an engine (e.g., an internal combustion engine), a motor, an energy source (e.g., a liquid fuel or electrical energy source or storage device, e.g., one or more batteries), a transmission, and a drive system (e.g., one or more shafts, belts, or power transmission components). In some implementations, the transmission is operable to cause the propulsion system to operate in a first configuration (so as to cause movement in a first direction) or a second configuration (so as to cause movement in a second direction) in response to an input received from a propulsion input device, as described in more detail below.

The brake system 22 may include, for example, a hydraulic system to pressurize and convey hydraulic fluid to one or more brake actuators (e.g., calipers, drum brakes, or other devices configured to apply a brake force) and rotors or other components configured to interact with the brake actuators to apply a brake force to the combine harvester 2. The combine harvester 2 also includes an operator station 24. In the illustrated example, the operator station 24 is, is included in, or is part of a cab 26 located at a forward end 28 of the combine harvester 2.

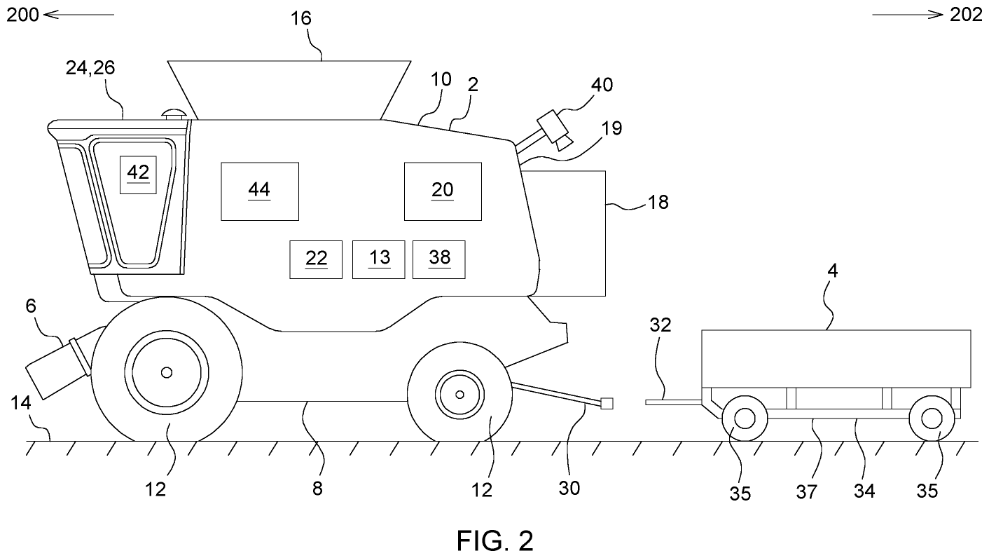

Referring to FIGS. 1 and 2, the combine harvester 2 also includes a hitch 30. The hitch 30 is configured to connect to the header 4 directly or indirectly. For example, the hitch 30, in some instances, the hitch connects to a tongue 32 of a trailer 34 used to transport the header 4. The trailer 34 includes ground engaging components 35, such as wheels (e.g., a combination of tires and wheels) or tracks, that allows the trailer 34 to move over the ground 14 and a frame 37 on which the ground engaging components 35 are mounted. The tongue 32 is connected to the frame 37. The header 4 is positioned on the trailer 34, and the trailer 34 is connected to the combine harvester 2 by connecting the hitch 30 to the tongue 32 of the trailer 34. In some instances, the hitch 30 includes any type of coupler that is operable to couple to the trailer 34, such as by releasably coupling to the trailer 34, to facilitate transport of the trailer 34 by the combine harvester 2. An example in which the header 4 is provided on the trailer 34 is described. However, this disclosure is applicable to and encompasses a header that can be pulled by a combine harvester without the use of a trailer.

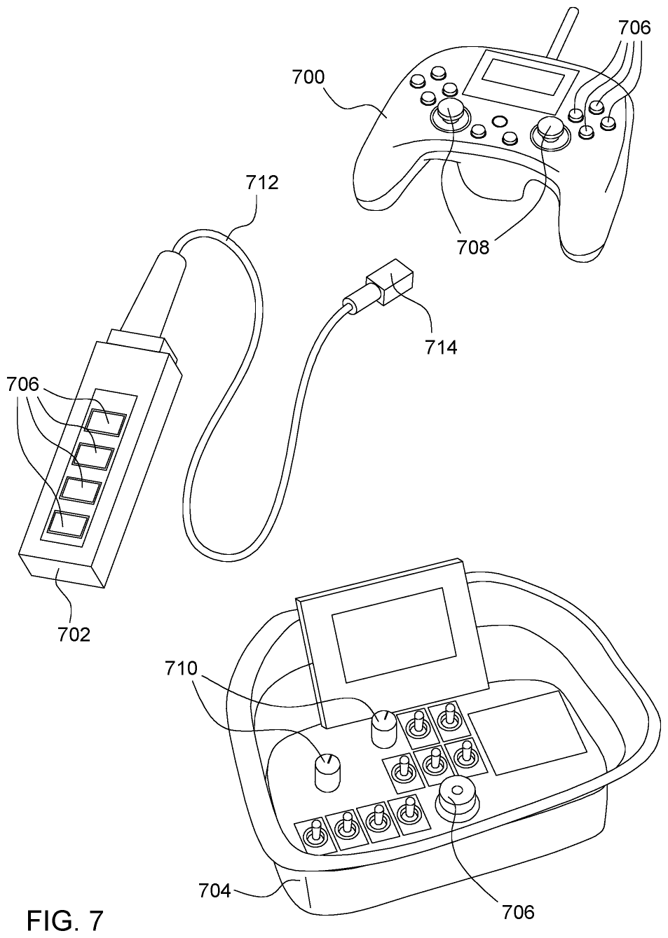

The combine harvester 2 also includes a control system 36 and a propulsion input device 38. The propulsion input device 38 is provided on the combine harvester 2 at a location proximate to the hitch 30. In some instances, the propulsion input device 38 is provided on an exterior surface of the combine harvester 2. In some implementations, a removable cover may be provided to shield the propulsion input device 38 from the environment when the propulsion input device 38 is not in use. In still other implementations, the propulsion input device 38 is a device that is removably connectable to the agricultural harvester 2. For example, in some implementations, the propulsion input device 38 is a tethered electronic controller that connects to a connector provided on the agricultural harvester 2, such as at a location proximate the aft end 19 of the agricultural harvester 2. In other implementations, the propulsion input device 38 is a wireless controller that communicates with a controller, such as controller 402 (described in more detail below). FIG. 7 shows a variety of example handheld propulsion input devices 700, 702, and 704, and one or more of these example handheld propulsion input devices 700 are operable to one or more of a control a propulsion system, a brake system, and a steering system to control movement of the agricultural harvester 2. Examples of handheld remotely operated propulsion input devices may include a plurality of input devices (e.g., one or more buttons, joysticks, sliders, touchscreens, dials, or other input devices) provided thereon for providing input into the propulsion input device 38. Particularly, in illustrated propulsion input devices 700 include buttons 706, joysticks 708, and dials 710. Other implementations may include other types of input devices. The example propulsion input devices 700 and 704 are wireless controllers, whereas the propulsion input device 706 is a wired controller and includes an electrical cord 712 and connector 714 to connect to the agricultural harvester.

As shown in FIGS. 1 and 2, the propulsion input device 38 is located or is connectable at a position on the combine harvester 2 such that an operator operating the propulsion input device 38 is able to see directly a portion of the hitch 30 that engages the tongue 32 (or other part of the trailer) that connects with the hitch 30. This visibility provided to the operator allows the operator to see a position of the hitch 30 relative to the tongue 32 as the operator controls movement of the combine harvester 2 with the propulsion input device 38, as described in more detail below. With this visibility, the operator is able to interact with the propulsion input device 38 to control movements of the combine harvester to couple the combine harvester 2 with the trailer 34. Movement control of the combine harvester 2 in this way includes forward and backward movement and, in some instances, lateral alignment, of the combine harvester 2 relative to the trailer 34. Thus, in some implementations, lateral alignment is controlled, e.g., via a steering system, to control a lateral position of the agricultural harvester 2. This control also includes the ability to stop the combine harvester 2 as desired by the operator, such as by actuation and deactivation (e.g., release) of the brake system 22.

In FIG. 2, the header 4 is located at a position aft of the combine harvester 2. That is, the header 4 is located behind the combine harvester 2 at a position adjacent to the aft end 19 of the combine harvester 2. In some implementations, an operator operates the combine harvester 2, such as from the operator station 24, to laterally align the combine harvester 2 with the header 4, which, in this example, is arranged on the trailer 34. However, as explained above, the header 4 may include features, e.g., one or more wheels, that allow the header 4 to be pulled or otherwise moved by the combine harvester 2 without the use of a trailer.

To accomplish this task of lateral alignment, one or more image devices and displays may be used. For example, the combine harvester 2 may include one or more image devices 40, such as one or more cameras (e.g., video camera, stereo camera) or other device operable to generate an image. In some instances, the images provided by the one or more image devices 40 is displayed to the operator, such as via one or more displays 42 included with the operator station 24, within the cab 26, or otherwise visible to the operator during operation of the combine harvester from the operator station 24.

Using one or more images, such as video images, the operator laterally aligns the combine harvester 2 with the trailer 34. With the combine harvester 2 and the trailer 34 aligned, the operator activates or enable (hereinafter collectively referred to as “enable” or “enabling”) use of the propulsion input device 38, such as by interacting with a control of the operator station 24. When the propulsion input device is not enabled, an input applied to the propulsion input device does not cause actuation of the systems communicably coupled to the propulsion input device. Thus, for example, when the propulsion input device is not enabled, an input applied to the propulsion input device to cause operation of the propulsion system does not cause operation of the propulsion input device. When the propulsion input device is enabled, input applied to the propulsion input device causes a system communicably coupled to the propulsion input device for which the input was made to operate according to the applied input.

In some implementations, enabling operation of the propulsion input device 38 causes the residue system 18 to move to a selected position. For example, in some instances, when the propulsion input device 38 is enabled, the residue system 18 to be raised to the selected position. Moving the residue system in this way provides for improved visibility when connecting the trailer 34 to the combine harvester 2 using the propulsion input device 38 and, in some instances, to provide for clearance between the residue system 18 and the trailer 34 when the trailer 34 is connected to the combine harvester 2.

With the propulsion input device 38 activated, the operator can utilize the propulsion input device 38 to control at least forward and aft movement of the combine harvester 2 at a position remote from the operator station 24 (e.g., remote from the cab 26). Thus, the operator can relocate to a position external of the cab 26 adjacent to the position adjacent to the propulsion input device 38 near the aft end 19 of the combine harvester 2. At this location, the operator can directly visually observe and control connection of the combine harvester 2 and the trailer 34.

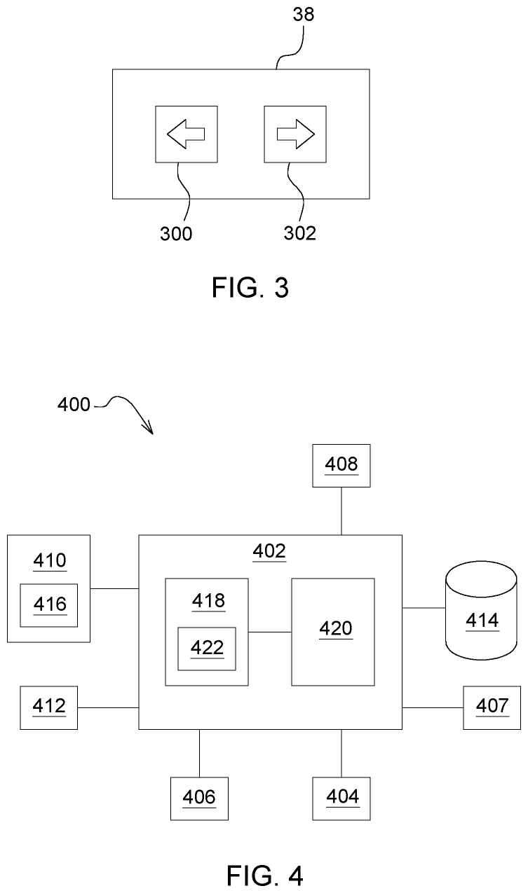

With the propulsion input device 38 engaged, the brake system 22 activates to apply a brake force to the combine harvester 2 to keep the combine harvester 2 stationary. FIG. 3 is an example propulsion input device 38 that includes a first input device 300 and a second input device 302. In the illustrated example, the first and second input devices are buttons. In other implementations, the input devices of the propulsion input device 38 may be other types of devices, such as one or more rockers switches, a touch screen display, or any other type of device to receive input from a user.

With reference to FIG. 3, the first input device 300 is used to control movement of the combine harvester 2 in a forward direction, and the second input device 302 is used to control movement of the combine harvester 2 in a reverse direction. In the arrangement shown in FIG. 2, activating the first input device 300 moves the combine harvester 2 in the forward direction indicated by arrow 200. Activating the second input device 302 moves the combine harvester 2 in the reverse direction indicated by arrow 202.

Activating the first input device 300 causes the brake system 22 to release the brake force applied to the combine harvester, such as to one or more of the ground engaging components 12 (or a component or assembly coupled thereto) or to a transmission (e.g., the transmission of the propulsion system 20), placing the combine harvester 2 into a configuration to allow the combine harvester 2 to move. Activation of the first input device 300 also configures the propulsion system 20 (including, as required) for moving the combine harvester 2 in a forward direction of arrow 200 and causes the propulsion system 20 to move the combine harvester 2 in the forward direction of arrow 200. In some instances, these actions are performed sequentially. In some instances, these actions occur concurrently. Movement of the combine harvester 2 continues for as long as the first input device 300 remains activated. For example, in an implementation where the first input device 300 is a button, depression of the first input device 300 sequentially causes the brake system 22 to release or remove a brake force and the propulsion system 20 to move the combine harvester 2 in the forward direction of arrow 200. Movement of the combine harvester 2 in the direction of arrow 200 continues for as long as the button of remains depressed. Deactivation of the first input device 300 stops the propulsion system 20 from moving the combine harvester in the direction of arrow 200 and operates the brake system 22 to reapply the brake force, thereby placing the combine harvester 2 in a static condition and in a condition to prevent movement of the combine harvester 2. In the context of the button, release of the button, for example, causes the propulsion system 20 to stop movement of the combine harvester 2 in the direction of arrow 200 and thereafter operate the brake system to apply the brake force to maintain the combine harvester 2 in a stationary condition.

Activation of the second input device 302 operates in similar manner to that described above with respect to the first input device 300. Activation of the second input device 302 operates the brake system 22 to release the brake force and operates the propulsion system 200 to move the combine harvester 2 in the direction of arrow 202. Deactivation of the second input device 302 causes the propulsion system 20 to stop movement of the combine harvester 2 in the direction of arrow 202 and operation of the brake system 22 to apply the brake force to keep the combine harvester 2 in a stationary condition. In instances where the second input device 302 is a button, movement of the combine harvester 2 in the direction of arrow 202 continues so long as the button remains depressed. Release of the button causes movement in the direction of arrow 202 to stop and application of the brake force. In some instances, these actions are performed sequentially. In some instances, these actions occur concurrently.

In other implementations, the propulsion input device 38 includes a three-position rocker switch in which, in a first position, the brake system is operable to apply a brake force and the propulsion system is idle, i.e., not providing a drive force to move the combine harvester 2. In a second position, the brake system 22 releases the brake force and the propulsion system 20 causes the combine harvester 2 to move in a first direction. Movement continues for as long as the rocker switch remains in the second position. In a third position, the brake system 22 releases the brake force and the propulsion system 20 causes the combine harvester 2 to move in a second direction, opposite the first direction. Movement continues for as long as the rocker switch remains in the second position.

The combine harvester 2 also includes an electronic controller 44. In some instances, the controller 44 may be a computer or computer system, such as computer 602 or computer system 600 described in more detail below. The electronic controller 44 is configured to control one or more operations of the combine harvester 2 in response to input received from the propulsion input device 38. In some implementations, the controller 44 may be configured to control other aspects of the combine harvester 2.

FIG. 4 is a schematic view of an example electronic control system 400 for controlling movement of a combine harvester in response to operation of a propulsion input device, as described here. The control system 400 includes an electronic controller 402, which may be similar to controller 44. The control system 400 also includes a brake system 404, which may be similar to brake system 22, and a propulsion system 406, which may be similar to propulsion system 20, both of which are communicably coupled to the controller 402. In some instances, the control system 400 also includes a steering system 407, which may be similar to steering system 13. The steering system 407 is communicably coupled to the controller 402. A propulsion input device 408, which may be similar to propulsion input device 38, is also communicably coupled to the controller 402. The propulsion input device 408 receives input, such as from an operator, to operate the propulsion system 406. For implementations that include the steering system 407, the propulsion input device 408 receives the input to operate both the propulsion system 406 and the steering system 407. The control system 400 also includes a display 410, an input device 412, and a database 414. In some implementations, the display 410, input device 412, and database 414 may be omitted. In some implementations, the display 410 is a touch screen that is operable to receive input from a user via a user's touch. In some implementations in which the display 410 is a touch screen, the input device 412 may be omitted.

The display 410 is operable to display information related to operation of the control system 400, such as information related to the propulsion system 406, the brake system 404, or other information. For example, the display 410 may display whether the brake system 404 is presently applying a brake force, whether the propulsion system 406 is presently causing the combine harvester to move and, if so, a direction of movement. In some instances, the information displayed by the display 410 is displayed via a graphical user interface (GUI) 416. Example graphical user interfaces are described in more detail below.

In some instances, the database 414 is a memory storage device that stores information used or associated with the control system 400. In some instances, the database 414 may store other types of information, such as information related to the combine harvester more generally.

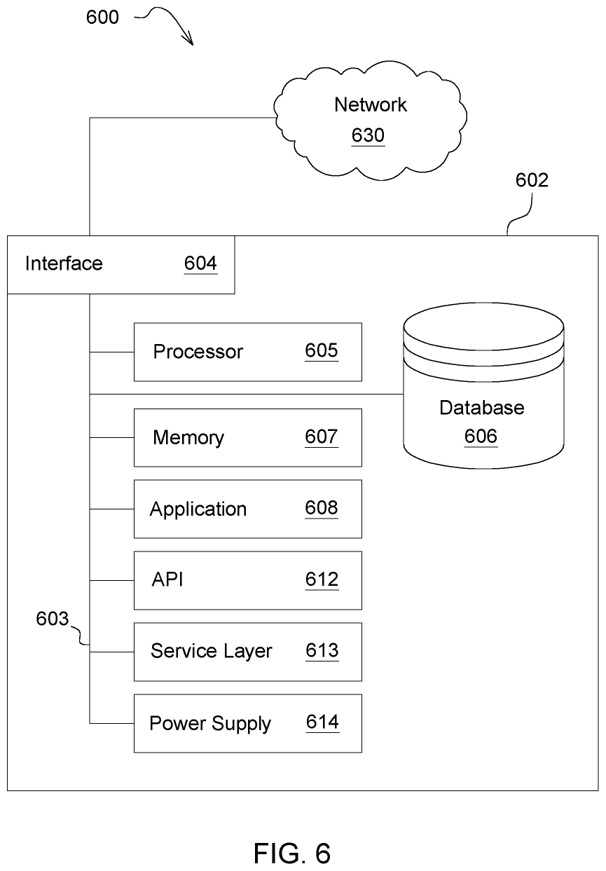

The controller 402 includes a processor 418 and a memory 420 communicably coupled to the processor 418. Additional details of the controller 402, such as processor 418 and memory 420, are described below in the context of computer 602. In some implementations, the controller 402 is communicably coupled with a network, such as in a manner described in more detail below in the context of FIG. 6. The memory 420 communicates with the processor 418 and is used to store programs and other software, information, and data. The processor 418 is operable to execute programs and software and receive information from and send information to the memory 420. Although a single memory 420 and a single processor 418 are illustrated, in other implementations, a plurality of memories, processors, or both may be used. Although the processor 418 and the memory 420 are shown as being local components of the controller 402, in other implementations, one or both of the processor 418 and memory 420 may be located remotely. The various components of the control system 400 are communicably coupled to the controller 402, such as via a wired or wireless connection.

Software 422, such as in the form of an application or program, is executed by the processor 418 to control operation of the control system 400, as described herein. Particularly, the software 422 includes executable instructions operable to control operation of the various components communicably coupled to the controller 402 and, as a result, control movement of the combine harvester, such as by controlling operation of the brake system 404 and the propulsion system 406. For example, the software 422 includes instructions to cause the processor 418 to perform example method 500, described in more detail below.

Example input devices, which may be used for input device 412, propulsion input device 408, or both, include a keyboard, keypad, one or more buttons, a slider bar, a multi-position switch, a dial, a knob, a mouse, a joystick, or wheel. The input devices 412 and 408 are used to receive input, such as from an operator or from another source. For example, the propulsion input device 408 is configured to receive input from a user to control movement of a combine harvester from a location remote from an operator station and, particularly, at a location adjacent to a hitch of a combine harvester.

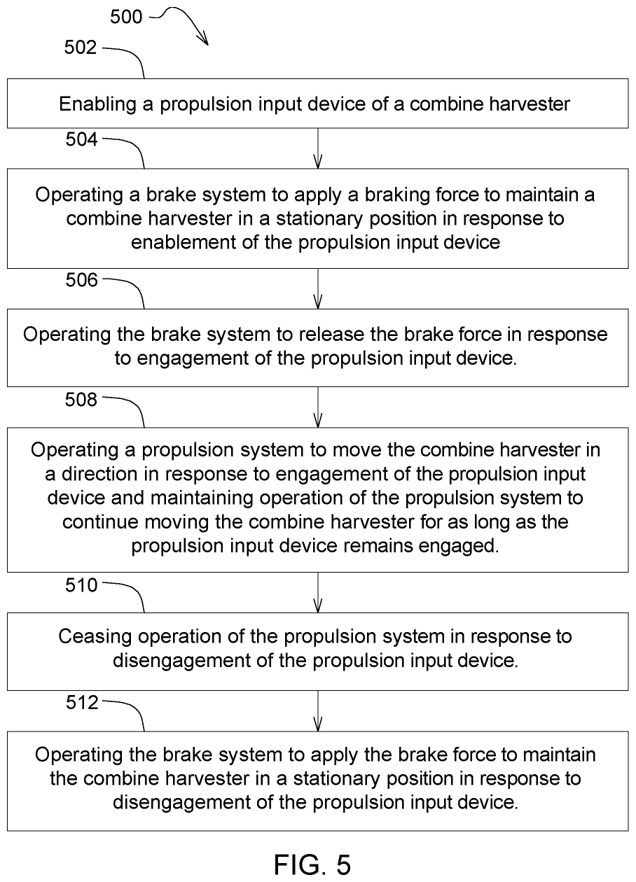

FIG. 5 is a flowchart of an example method 500 for moving a vehicle, such as an agricultural vehicle, using an input device that is located remote from an operator station. For example, the input device may be positioned near an aft end of an agricultural vehicle at a location providing visibility of a hitch of the agricultural vehicle, thereby facilitating connection of the agricultural vehicle to another piece of equipment, such as a header or trailer.

At 502, a propulsion input device is enabled. In some implementations, the propulsion input device, such as propulsion input device 38 or 508, is enabled by providing an input at an operator station, such as within a cab of a combine harvester. The propulsion input device may be located at an aft location of the combine harvester, accessible from an exterior of the combine harvester, and provide visibility to a hitch or other coupling device of the combine harvester used to connect to a header or trailer carrying the header. At 504, in response to enablement of the propulsion input device, a brake system of the combine harvester is operated to apply a brake force to maintain the combine harvester in a stationary position. At 506, in response to engagement of the propulsion input device, such as by an operator, the brake system is operated to release the brake force. In some instances, the propulsion input device provides an output to control movement of the combine harvester in a first direction and a second direction. Further, in some implementations, the propulsion input device includes a first input device to control movement in a first direction (e.g., movement in a forward direction) and a second input device to control movement in a second direction, opposite the first direction (e.g., movement in a rearward direction). At 508, the propulsion system is operated to move the combine harvester in a direction (e.g., the first direction or the second direction, depending on which input device of the propulsion input device that has been engaged) in response to engagement of the propulsion input device, and movement is maintained for a duration that the propulsion input device remains engaged. Thus, if the propulsion input device includes a button, movement will continue for as long as the button remains depressed. At 510, operation of the propulsion system ceases in response to disengagement of the propulsion input device. For example, movement of the combine harvester ceases once the button of the propulsion input device is no longer being depressed. At 512, the brake system is operated to apply the brake force to maintain the combine harvester in a stationary position.

As explained, in some instances, the propulsion input device may include two input devices (e.g., buttons) to control coordination and operation of the brake system and propulsion system to control movement of the combine harvester by an operator from a position external to the combine harvester and at a location near the aft end of the combine harvester so that the operator can see the header located near the hitch to control coupling of the combine harvester with a header or trailer. Thus, while a single direction of movement is described in the method 500, a second direction of movement can also be controlled in a similar manner.

Without in any way limiting the scope, interpretation, or application of the claims appearing below, a technical effect of one or more of the example implementations disclosed herein is controlling movement of a vehicle outside of an operator station, e.g., cab of the vehicle, and with improved visibility (e.g., direct visibility) of a coupling device (e.g., hitch of the vehicle) so as to facilitate coupling of the vehicle with another piece of equipment. Another technical effect of one or more of the example implementations disclosed herein is reducing an amount of time needed to couple vehicle to the other piece of equipment.

In some implementations, the method 500 may also involve providing a steering input to the combine harvester. In some implementations, the input to the propulsion input device that operates to control operation of the brake system and the propulsion system is also used to control a steering system of the combine harvester, which may be similar to steering system 13. For example, in some instances, a joystick, such as the joystick 708, of propulsion input device 700 is pivoted forward to control forward movement of the combine harvester, while a lateral pivoting movement operates to provide a steering input to steer the combine harvester in the corresponding direction of the lateral pivot movement. A combination of a forward (or rearward) movement and a steering movement may be combined by pivoting the joystick in a diagonal direction that is between a forward (or rearward) movement and a lateral movement of the joystick. In this way, a simultaneous forward or rearward movement along with a steering input is accomplished.

In other implementations, separate input devices (e.g., one or more button, dials, or joysticks) on the propulsion input device is used to control the steering system and the propulsion system separately. These controls may be used in combination with each other to effectuate a forward and lateral movement or a rearward and lateral movement of the combine harvester, i.e., to steer the combine harvester to one side or another while moving the combine harvester forward or rearward.

In some implementations, a steering input made to the propulsion input system releases a brake force. In other implementations, a steering input does not release a brake force. Thus, in some implementations, a brake force is release when an input to the propulsion input device is made to operate the propulsion system but not when a steering input is made.

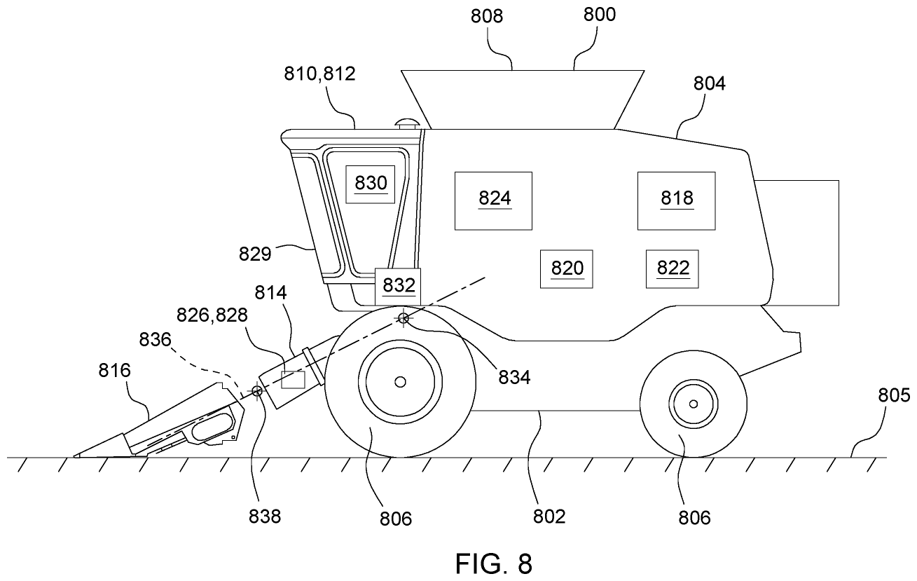

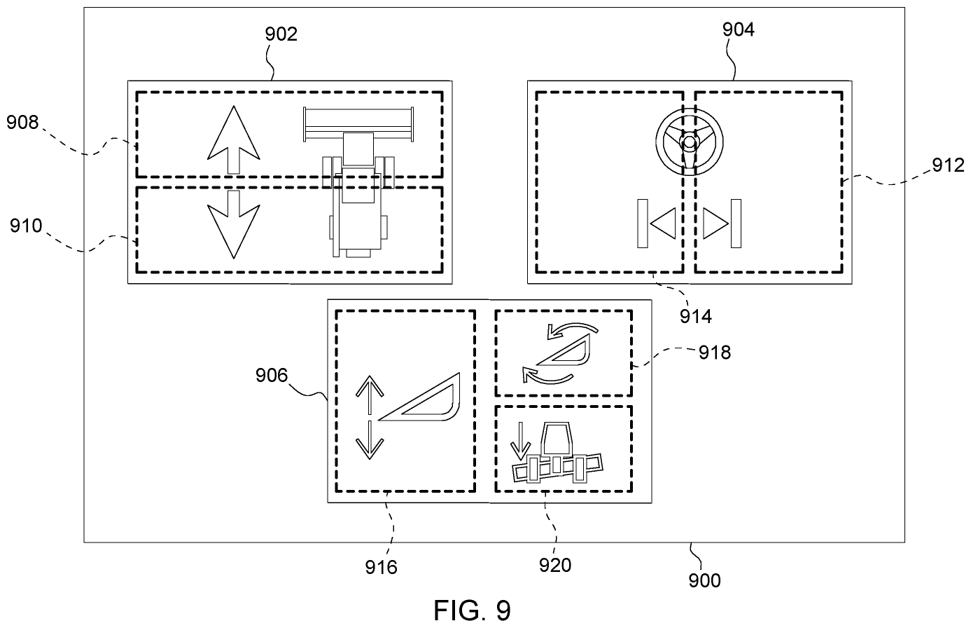

FIG. 8 is side view of an example combine harvester 800 that may be similar to combine harvester 2, described above. Similar to the combine harvester 2, the combine harvester 800 includes a frame 802, a body 804 mounted to a frame 802, and ground engaging components 806 coupled to the frame 802. The ground engaging components 806 are in contact with the ground 805 and may be similar to the ground engaging components 12 described earlier. The body 804 includes a grain tank 808 and an operator station 810. In this example, the operator station 810 is, is included in, or is part of a cab 812. The combine harvester 800 also includes a feederhouse 814 to which a header connects. As shown, a header 816 is positioned forward of the combine harvester 800 and is disconnected therefrom.

The combine harvester 800 also includes a propulsion system 818 (which may be similar to the propulsion system 20), a brake system 820 (which may be similar to the brake system 22), a steering system 822, and a controller 824 (which may be similar to the controller 44). Additionally, the combine harvester includes a propulsion input device 826 or a location where the propulsion input device 826 is connectable to the combine harvester 800. In some implementations, the propulsion input device 826 is integrated into the combine harvester 800. For example, in some instances, the propulsion input device 826 is integrated into an exterior surface of a component of the combine harvester 800. In some implementations, the propulsion input device 826 is integrated into a component of the combine harvester 800 and is protected by a removable cover that, when opened or removed, provides access to the propulsion input device 826 and, when closed, protects the propulsion input device 826 from the environment.

In some implementations, the propulsion input device 826 may be an untethered remotely operated device. For example, in some implementations, the propulsion input device is a wireless handheld device, examples of which are described earlier. In other implementations, the propulsion input device 826 is a tethered device, such as propulsion input device 702. The propulsion input device 826 communicates with the controller 824, e.g., via a wired connection, an electrical cable connected to the combine harvester 800, or a wireless connection. The controller 824 is operable to control the propulsion system 818, the steering system 822, the brake system 820, and a feederhouse position system 832, described in more detail below. In the illustrated example of FIG. 8, the tethered propulsion input device 826 connects at location 828. Although the location 828 is provided on the feederhouse 814, in other implementations, the location 828 may be provided at other locations on the combine harvester. For example, in some instances, the location 828 is on or proximate to a forward end 829 of the combine harvester 800. The location 828 may be selected so that, when the propulsion input device 826 is connected, the operator has a view of the feederhouse 814 and header 816 and, particularly, a position where the feederhouse 814 and the header 816 connect to each other. The combine harvester 800 also includes a display 830, which may be similar to display 42 described earlier.

In still other implementations, the propulsion input device 826 is located on the combine harvester 800 at the location 828. With an operator positioned adjacent to location 828, the operator is able to see, directly, the coupling of the header 816 to the feederhouse 814 of the combine harvester 800 and use the propulsion input device to control the coupling thereof. At this location, the operator is provided with visibility that may be improved compared to the visibility provided from the operator station 810.

The combine harvester 800 also includes a feederhouse position system 832 that is operable to alter a position (e.g., orientation) of the feederhouse 814. In some instances, the feederhouse position system 832 includes a plurality of actuators that function to pivot the feederhouse 814 about one or more axes, such as a lateral horizontal axis 834 and a longitudinal axis 836. In some implementations, the feederhouse position system 832 may include one or more actuators to pivot a header attached to the feederhouse along a lateral axis 838.

FIG. 9 is a front view of an example propulsion input device 900. The propulsion input device 900 includes a plurality of input devices 902 through 906, such as buttons, switches, touch sensitive areas, or other input devices, used to control operation of a combine harvester or other vehicle to which the propulsion input device 900 is connected. In some instances, the propulsion input device 900 is attached to an exterior surface of the combine harvester. In other implementations, the illustrated propulsion input device 900 is or is part of a handheld device that is tether or wirelessly connected to the combine harvester.

Referring to FIG. 9, the input device 902 may be a three-position rocker switch or a pair of buttons, for example. In the instance of the three-position rocker switch, for example, a center position is a default position to which the switch defaults when no input is applied. In this example, application of a force to a first portion 908 of the input device 902, the rocker switch rocks or pivots in a first direction (e.g., upwards) to a first position. In response to being pivoted in the first direction, a brake system releases an applied brake force, and a propulsion system operates to cause the combine harvester to move forwards. Alternately, application of a force to a second portion 910 causes the rocker switch to pivot in a second direction, opposite the first direction (e.g., downwards), to a second position. As a result, the brake system releases the brake force, and the propulsion system causes the combine harvester to move in a reverse direction. Removal of a force from the first portion 904 or the second portion 906 causes the rocker switch to return to the center location, causing the propulsion system to stop applying a motive force to the combine harvester and causing the brake system to apply the brake force to keep the combine harvester stationary.

Similarly, the input device 902 may also be a three-position rocker switch that includes a default center position, a first position to which the switch pivots in a first direction in response to application of a force to portion 912, and a second position to which the switch pivots in a second direction in response to application of a force to portion 914. Actuation of the switch to the first position causes the steering system to pivot at least one of the ground engaging components about a steering axis in a first direction. Pivoting the one or more ground engaging components about the steering axis in the first direction to place the at least one ground engaging component in a first angular range is effective to turn the combine harvester in a first direction when moving forward or in reverse. Actuation of the switch to the second position causes the steering system to pivot the at least one ground engaging component about the steering axis in a second direction. Pivoting the one or more ground engaging components about the steering axis in the second direction to place the at least one ground engaging component in a second angular range is effective to turn the combine harvester in a second direction when moving forward or in reverse. In some implementations, the steering system includes one or more actuators that operate to generate a moment that pivots the one or more ground engaging components about the steering axis. In some instances, the one or more actuators are actuated in response to an input applied to the propulsion input device. In some instances, each of the ground engaging components that is moveable in response to a steering input applied to the propulsion input device 900 pivots about a respective steering axis. For example, if both ground engaging components at a rear of the combine harvester are steerable, each of these ground engaging components pivots about a respective steering axis to effectuate steering of the combine harvester.

Pivoting the at least one ground engaging components about the steering axis includes altering an orientation of the ground engaging component relative to a least a portion of the frame of the combine harvester. Altering an orientation of the ground engaging component in this way is used to change a direction of travel of the vehicle when the vehicle is being propelled forwards or backwards.

Operating a steering system to pivot one or more ground engaging components relative to at least a portion of a frame of a vehicle to steer the vehicle encompasses articulated vehicles. An articulating vehicle is one in which a first portion of the vehicle frame is pivotably connected (e.g., about a vertical axis) to a second portion of the frame. Ground engaging components are attached to each of the first and second portions of the frame. Actuation of the one or more actuators causes the first portion of the frame to pivot relative to the second portion of the frame. Thus, when the first frame portion is pivoted relative to the second frame portion, ground engaging components connected to the first frame portion are pivoted relative to, and an orientation thereof is changed relative to, the second frame portion. When the vehicle is moving, articulating the vehicle in this way effectuates a turn of the vehicle. Thus, the scope of the present disclosure encompasses articulating vehicles, and operating a steering system to pivot one or more ground engaging components relative at least a portion of a vehicle frame encompasses pivoting a first portion of a frame of the vehicle relative to a second portion of the frame of an articulating vehicle.

The input device 906 is used to control movement of the feederhouse of the combine harvester. The input device 906 may be a touch sensitive pad or screen or a group of buttons. Other input devices are also within the scope of the disclosure. Interacting with area 916 causes a feederhouse position system, such as feederhouse position system 832, to raise the feederhouse and lower the feederhouse. For example, in some instances, one or more actuators (e.g., hydraulic or electrical actuators) of the feederhouse position system to raise or lower the feederhouse. Altering a height of the feederhouse above the ground can be useful to align a coupling of the feederhouse with a corresponding coupling on the head. Interacting with area 918 actuates, for example, one or more actuators of the feederhouse position system that causes a coupling, provided on the feederhouse that engages the header, to rotate about a horizontal axis in a first rotational direction and a second rotational direction. With the header connected, interacting with area 918 operates to rotate the header about the horizontal axis. Interacting with area 920 controls a feederhouse position system to control a position of the feederhouse. For example, in some implementations interacting with are 920 causes one or more actuators of the feederhouse position system to cause the feederhouse to pivot in a first rotational direction or a second rotational direction about a longitudinal axis. Similarly, with a header attached, interacting with area 920 causes the header to pivot about the longitudinal axis in the first rotational direction or the second rotational direction.

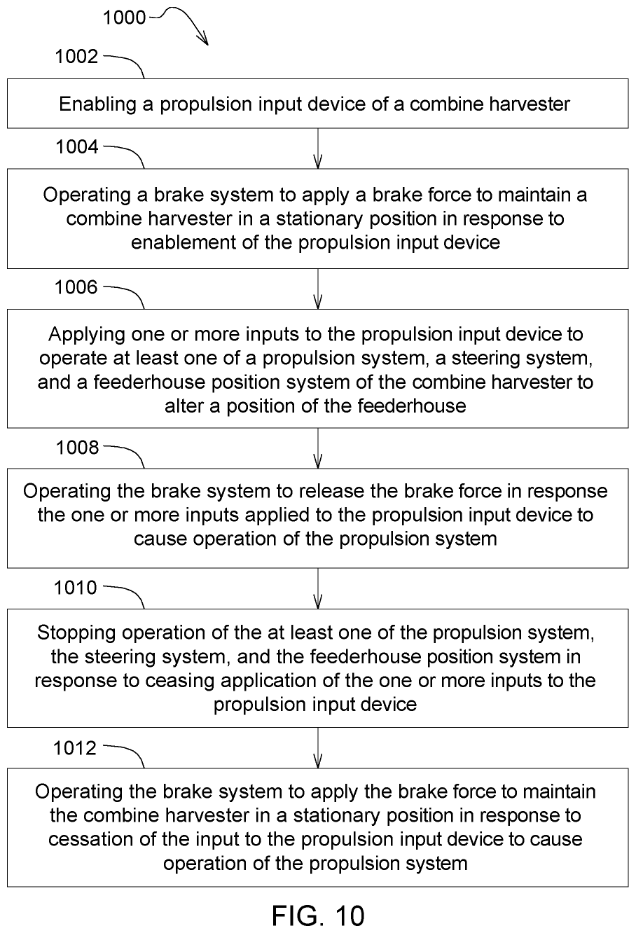

FIG. 10 is a flowchart of an example method 1000 to manipulate a position of an agricultural vehicle, such as a combine harvester, for the purpose of coupling an implement, such as a header, to the agricultural vehicle. At 1002, a propulsion input device is enabled. In some implementations, the propulsion input device, such as propulsion input device 826 or 900, is enabled by providing an input at an operator station, such as within a cab of a combine harvester. The propulsion input device may be located at a forward location of the combine harvester, accessible from an exterior of the combine harvester. For example, the propulsion input device may be provided on a feederhouse of the combine harvester or another location that provides an operator with visibility of an area forward of the harvester to, thereby, allow the operator to directly view a coupling operation between the feederhouse and a header. In other implementations, the propulsion input device is connectable to a location at the forward end of the combine harvester. In other implementations, the propulsion input device is a wirelessly communicably coupled handheld device, for example, as described herein.

At 1004, in response to enablement of the propulsion input device, a brake system of the combine harvester is operated to apply a brake force to maintain the combine harvester in a stationary position.

At 1006, one or more inputs is applied to the propulsion input device to operate one of the propulsion system, the steering system, or the feederhouse position system is operated to alter a position of the feederhouse in an effort, for example, to connect the feederhouse with a header, such as a header positioned on the ground. Using the propulsion input device, the combine harvester can be moved forwards or backwards, turned in a first direction or a second direction, or a combination thereof and a position of the feederhouse relative to the frame of the combine harvester can be altered, for example, to align and couple the feederhouse to a header. In some implementations, the propulsion input device includes one or more input devices to control each of these systems, i.e., the propulsion system, the steering system, and the feederhouse position system. Each of these systems is operated to cause movement of the feederhouse, the combine harvester more generally, or both in response to application of an input to these one or more input device. One or more of these systems continues for so long as the respective input remains applied to the propulsion input device.

At 1008, the brake system of the combine harvester operates to release the brake force in response to application of an input to the propulsion input device to cause operation of the propulsion system. In some instances, the propulsion input device, in response to an input to cause operation of the propulsion system, provides an output to the propulsion system to cause movement of the combine harvester in one of a first direction and a second direction. Thus, the brake system releases the brake force in response to an input to the propulsion input device to cause operation of the propulsion system. In some instances, the brake system releases the brake force in response to an input to the propulsion input device to actuate the steering system.

In some implementations, the propulsion input device includes a first input device to control movement in a first direction (e.g., movement in a forward direction) and a second input device to control movement in a second direction, opposite the first direction (e.g., movement in a rearward direction). In some instances, the propulsion input device includes a third input device to control steering of the combine harvester in a first direction and a fourth input device to control steering of the combine harvester in a second direction, as described earlier. Further, in some implementations, the propulsion input device includes one or more additional input devices to control movement of the feederhouse. These input devices can be used to alter a position of the feederhouse to assist in coupling the header to the feederhouse. Thus, these input devices to control movement of the feederhouse, in combination with the input devices to control movement of the combine harvester forward and aft and to control a direction of movement, can be used to connect the header to the feederhouse of the combine harvester. Further, the operator, located apart from the operator station and having the ability to directly see the feederhouse, can effectively and quickly join the header to the feederhouse.

At 1010, operation of these systems stops when the application of the input to the respective input device or devices of the propulsion input device ceases. Thus, for example, if the propulsion input device includes a button to cause the propulsion system to move the combine harvester forwards, movement of the combine harvester in the forward direction will continue for as long as the button remains depressed. Once the input is no longer applied to the input device, movement of the combine harvester ceases. Movement of the steering system and the feederhouse position system may be controlled in a similar manner. That is, in the context of a button, movement continues until the button is no longer depressed. More generally, the action commanded by an input to the propulsion input device continues until the input is no longer applied to the propulsion input device.

At 512, the brake system is operated to apply the brake force to maintain the combine harvester in a stationary position in response to the input to the propulsion input device to cause the propulsion system to operate being ceased. As explained above, application to cause the steering system to operate may cause the brake system to remove the brake force. In such instances, cessation of the input to cause the steering system to operate causes the brake system to apply the brake force.

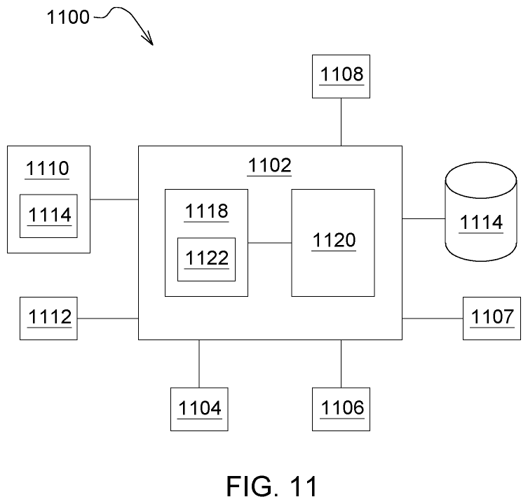

FIG. 11 is a schematic view of an example electronic control system 1100 for controlling movement of a combine harvester in response to operation of a propulsion input device, as described here. The control system 1100 may be similar to the control system 400. Thus, the details of the control system 1100 may be similar to those explained above for control system 400.

The control system 1100 includes an electronic controller 1102, which may be similar to controller 44, 402, or 824. The control system 1100 also includes a brake system 1104, which may be similar to brake system 22, 404, or 820; a propulsion system 1106, which may be similar to propulsion system 20, 406, or 818; and a steering system 1107, which may be similar to steering system 407 or 822, all of which are communicably coupled to the controller 1102. A propulsion input device 1108, which may be similar to propulsion input device 38, 408, or 826, is also communicably coupled to the controller 1102. The propulsion input device 1108 receives input, such as from an operator, to operate the propulsion system 1106 and the steering system 407. The control system 400 also includes a display 1110, an input device 1112, and a database 1114. The display 1110 may include a GUI 1116, which may be similar to GUI 416. The display 1110, the input device 1112, and the database 1114 may be similar to the display 410, the input device 412, and the database 414, respectively. As such, detailed descriptions thereof are omitted. In some implementations, the display 1110, input device 1112, and database 1114 may be omitted.

Similar to the controller 402, the controller 1102 includes a processor 1118 and a memory 1120, which are similar to the processor 418 and the memory 420, respectively. As such, the details of the processor 1118 and memory 1120 are omitted. The processor 1118 executes software 1122, which may be similar to software 422. In some implementations, the software 1122 includes executable instructions operable to control operation of the various components communicably coupled to the controller 1102 and, as a result, control movement of the combine harvester, such as by controlling operation of the brake system 1104, the propulsion system 1106, and the steering system 1107. For example, the software 1122 includes instructions to cause the processor 1118 to perform example method 1000, described in earlier.

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. An agricultural harvester comprising:
a frame;
a body coupled to the frame;
a feederhouse movable relative to the body;
a feederhouse position system configured to move the feederhouse;
a ground engaging component coupled to the frame, the ground engaging component configured to move the agricultural harvester over a surface;
a propulsion system configured to drive the ground engaging component;
a propulsion input device in communication with the propulsion system and the feederhouse position system, the propulsion input device configured to receive input to control operation of the propulsion system and the feederhouse position system; and
an electronic controller communicably coupled to the propulsion input device, the electronic controller including:
one or more processors; and
a non-transitory computer-readable storage medium coupled to the one or more processors and storing programming instructions for execution by the one or more processors, the programming instructions instruct the one or more processors to:
operate the propulsion system in one of a first configuration to drive the ground engaging component in a first direction or a second configuration to drive the ground engaging component in a second direction, opposite the first direction, in response to a first input received by the propulsion input device, the propulsion system being operated for a duration of time that the propulsion input device receives a first input;
cease operation of the propulsion system in response to cessation of the first input being applied to the propulsion input device; and
move the feederhouse relative to the body in response to a second input received by the propulsion input device.

2. The agricultural harvester of claim 1, wherein the programming instructions include programming instructions to instruct the one or more processors to:
maintain movement of the feederhouse relative to the body for so long as the second input is received by the propulsion input device; and
cease movement of the feederhouse in response to cessation of the second input being applied to the propulsion input device.

3. The agricultural harvester of claim 1, wherein the programming instructions include programming instructions to instruct the one or more processors to move the feederhouse relative to the body in response to the second input received by the propulsion input device include programming instructions to instruct the one or more processors to at least one of pivot the feederhouse about a lateral horizontal axis and pivot the feederhouse about a longitudinal horizontal axis.

4. The agricultural harvester of claim 1, further comprising a steering system configured to alter a configuration of at least one of the ground engaging components,
wherein the programming instructions include programming instructions to instruct the one or more processors to cause the steering system to:
pivot the ground engaging component relative to at least a portion of the frame in response to a third input received by the propulsion input device; and
maintain pivoting of the ground engaging component for so long as the third input is received by the propulsion engaging device.

5. The agricultural harvester of claim 1, wherein the propulsion input device is physically attached at a location of the agricultural harvester.

6. The agricultural harvester of claim 5, wherein the propulsion input device is physically attached to the location via an electrical tether that provides communication with the electronic controller.

7. The agricultural harvester of claim 1, wherein the prolusion input device is wirelessly communicably coupled to the electronic controller.

8. The agricultural harvester of claim 1, wherein the programming instructions include programming instructions to instruct the one or more processors to enable operation of the propulsion input device in response to receipt of a third input.

9. The agricultural harvester of claim 2, wherein the body includes an operator station, and wherein the third input is received from the operator station.

10. The agricultural harvester of claim 3, wherein the operator station is a cab of the body.

11. The agricultural harvester of claim 1, further comprising a brake system,
wherein the propulsion system includes a transmission, and
wherein the programming instructions that instruct the one or more processors to operate the propulsion system in one of a first configuration to drive the ground engaging component in a first direction or a second configuration to drive the ground engaging component in a second direction, opposite the first direction, in response to an input received from the input device, the propulsion system being operated for a duration of time that the propulsion input device receives a first input, include programming instructions that instruct the one or more processors to:
place the brake system in a release condition in which a braking force is not applied; and
operate the transmission to cause the propulsion system to operate in the one of the first configuration and the second configuration for as long as the first input is received from the propulsion system input.

12. The agricultural harvester of claim 11, wherein the programming instructions that instruct the one or more processors to cease operation of the propulsion system in response to cessation of the first input being applied to the input device include programming instructions that instruct the one or more processors to place the brake system in an engaged condition in which the braking force is applied.

13. A computer-implemented method for controlling movement of an agricultural harvester, the method comprising:
operating a propulsion system of the agricultural harvester in one of a first configuration to drive a ground engaging component of the agricultural harvester in a first direction or a second configuration to drive the ground engaging component in a second direction, opposite the first direction, in response to a first input received by a propulsion input device of the agricultural harvester, the propulsion system being operated for a duration of time that the propulsion input device receives a first input; and
operating a steering system to pivot the ground engaging component relative to at least a portion of a frame of the agricultural harvester in response to a second input received by the propulsion input device, operation of the steering system continuing for so long as the second input is received by the propulsion engaging device.

14. The computer-implemented method of claim 13, further comprising ceasing operation of the propulsion system in response to cessation of the first input being applied to the propulsion input device.

15. The computer-implemented method of claim 13, further comprising ceasing operation of the steering system in response to cessation of the second input being applied to the propulsion input device.

16. The computer-implemented method of claim 13, further comprising enabling operation of the propulsion input device in response to a third input.

17. The computer-implemented method of claim 16, wherein enabling operation of the propulsion input device in response to the second input includes receiving the third input via an operator station of the agricultural harvester.

18. The computer-implemented method of claim 13, wherein operating the propulsion system of the agricultural harvester in one of the first configuration to drive the ground engaging component of the agricultural harvester in the first direction or the second configuration to drive the ground engaging component in the second direction, opposite the first direction, in response to the first input received from the propulsion input device provided on the exterior surface of the agricultural harvester includes receiving the first input from the propulsion input device disposed at an aft portion of the agricultural harvester.

19. The computer-implemented method of claim 13, wherein operating the propulsion system of the agricultural harvester in one of the first configuration to drive the ground engaging component of the agricultural harvester in the first direction or the second configuration to drive the ground engaging component in the second direction, opposite the first direction, in response to the first input received from the input device includes:
disengaging a brake system of the agricultural harvester to release a brake force; and
operating a transmission of the propulsion system to cause the propulsion system to operate in the one of the first configuration and the second configuration for as long as the first input is received from the propulsion system input device.

20. The computer-implemented method of claim 19, wherein ceasing operation of the propulsion system in response to cessation of the first input being applied to the propulsion input device includes engaging the brake system to apply a brake force to the ground engaging component.
